(19) United States
(12) Patent Application Publication
(10) Pub. No.: US 2022/0250018 A1
(43) Pub. Date: Aug. 11, 2022

(54) INLINE MIXER DEVICE, METHODS OF MIXING, AND METHODS OF MAKING AN INLINE MIXER DEVICE

(71) Applicant: Parker-Hannifin Corporation, Cleveland, OH (US)

(72) Inventor: David Hosterman, Oxnard, CA (US)

(73) Assignee: Parker-Hannifin Corporation, Cleveland, OH (US)

(21) Appl. No.: 17/733,435

(22) Filed: Apr. 29, 2022

Related U.S. Application Data
(63) Continuation of application No. PCT/US2020/056872, filed on Oct. 22, 2020.
(60) Provisional application No. 62/930,125, filed on Nov. 4, 2019.

(51) Int. Cl. B01F 25/431; B29C 45/14

(52) U.S. Cl. CPC B01F 25/4319; B01F 25/4317; B29L 2023/005; B29C 45/14622; B01F 25/43197

(57) ABSTRACT

An inline mixer device includes a flexible tube and a mixer portion. The mixer portion is internal to and integral with the tube. The mixer portion and tube may be comprised of the same flexible material. Methods of forming the inline mixer device are provided. Methods of mixing fluid with the inline mixer device are provided.

### CROSS-REFERENCE TO RELATED PATENT APPLICATIONS

This patent application is a Continuation of PCT Application No. PCT/US2020/056872, filed Oct. 22, 2020, which is now pending. This patent application claims the benefit of U.S. Provisional Patent Application No. 62/930,125, filed Nov. 4, 2019, the entire teachings and disclosure of which are incorporated herein by reference thereto.

### FIELD OF THE INVENTION

The present invention relates to inline mixer devices.

### BACKGROUND OF THE INVENTION

The biopharma industry often must mix bioprocessing fluids. For example, concentrated fluids are often diluted with other fluids such as water before use. For the biopharma industry, existing disposable mixers typically require large mixing reservoirs. An example is the GE Xcellerex XDM®.

Known mixers are used for mixing materials such as adhesives, paints, municipal water, and food, but some materials used in the construction of these mixers are not suitable for the biopharma industry. Further, typical end connections for the known mixers are flanges or threaded or welded ends. However, such connections are also not widely used in the biopharma industry.

Most existing mixers are made with the mixing elements as separate pieces that are inserted into a tube and affixed on the ends. Further, most known mixers have mixing elements that are rigid or part of rigid piping such that to change mixing characteristics of the mixer, either new mixing elements are needed or the entire tube and mixing element assembly need be replaced.

Some prior mixers are illustrated in U.S. Pat. Nos. 8,147,124 and 8,322,381; U.S. Pat. Publ. Nos. US 2002/0036951 and US 2006/0176764; as well as the SMU-1 Series inline static mixers distributed by Parker-Hannifin Corporation of Cleveland Ohio.

### SUMMARY

The application provides a new and improved inline mixer device that provides inline mixing of fluid flowing therethrough.

In an example, an inline mixer device includes a flexible tube portion and a mixer portion. The mixer portion is internal to and integral with the tube portion. The mixer portion and tube portion are comprised of flexible material.

In one example, the material is the same for both the mixer portion and the tube portion.

In one example, the mixer portion has a length. The mixer portion is bonded along the length to an internal wall of the tube portion by molding the mixer portion to the internal wall of the tube portion. The bond between the mixer portion and the tube portion does not include a separate bonding material. In one example, the bonding is provided by cross-link bonding. This cross-link bonding can occur due to heating of the flexible material.

In one example, the tube portion and mixer portion are a thermoset material. In a particular example, the thermoset material is silicone.

In one example, the tube portion and mixer portion are a thermoplastic elastomer material that is flexible.

In one example, the tube portion has a tube wall that defines an internal flow path having an inner diameter. The mixer portion, at least in part, projects radially inward from the tube wall providing a non-cylindrical flow path through the tube portion. In one example, mixing elements of the mixer portion project radially inward from the tube wall a distance larger than fifty percent the inner diameter of the tube portion.

In one example, the tube portion has a first section, a second section and a third section. The second section is positioned axially between the first and third sections. The first and third sections have a first outer diameter and the second section has a second outer diameter different than the first outer diameter.

In one example, the first section has a first wall portion, the second section has a second wall portion, the third section has a third wall portion. The mixer portion, at least in part, projects radially inward from the first wall portion, the second wall portion and the third wall portion.

In one example, the mixer portion has a first mixing element and a second mixing element. The first mixing element is distinct from the second mixing element. The first mixing element extends radially inward from the first wall portion and the second wall portion. The second mixing element extending radially inward from the third wall portion and the second wall portion. The first mixing element does not extend from the third wall portion and the second mixing element does not extend from the first wall portion.

In one example, the first mixing element is a first helical projection extending a first angular direction about a central axis of the tube portion and longitudinally along the central axis. The second mixing element is a second helical projection extending a second angular direction about the central axis of the tube portion and longitudinally along the central axis. The second angular direction is opposite the first angular direction.

In one example, the tube portion and the mixer portion are formed as a single one-piece molded component.

In one example, the tube portion and mixer portion form a unitary component.

In one example, an inner diameter of the second section is larger than an inner diameter of the first and third sections.

In one example, the tube portion and mixer portion are free of crevices or gaps formed between the tube portion and the mixer portion and particularly an inner surface of the tube portion and the mixer portion.

In one example, the first mixing element extends only a portion of a length of the first wall portion and only a portion of a length of the second wall portion. The second mixing element extends only a portion of a length of the third wall portion and only a portion of the length of the second wall portion.

In one example, a portion of the length of the first wall portion that is free of the first mixing element provides a smooth cylindrical inner surface free of any mixer portions or mixing elements. A portion of the length of the third wall portion that is free of the second mixing element provides a smooth cylindrical inner surface free of any mixer portions or mixing elements. These cylindrical inner surfaces provide for good sealing with connectors that may be inserted into the first and second wall portions.

In one example, the flexible tube portion includes a first length of flexible tube and a second length of flexible tube. The mixer portion fluidly and mechanically connects a first end of the first length of flexible tube to a first end of the second length of flexible tube. The first and second lengths of flexible tube may be preformed tube.

In one example, the mixer portion forms a portion of the flexible tube portion and is axially positioned between the first end of the first length of flexible tube and the first end of the second length of flexible tube. The mixer portion may form or otherwise be part of a connection portion that connects the first and second lengths of flexible tube. The connection portion forms part of the tube portion a long with the first and second lengths of flexible tube.

In one example, a portion of the mixer portion extends into each of the first and second lengths of flexible tube and around the outer periphery of at least a portion of each of the first and second lengths of flexible tube. This is beneficial when the mixer portion connects the first and second lengths of flexible tube to one another. In this arrangement, a portion of the mixer may define a portion of the flexible tube portion and the flow path defined thereby.

In one example, the first and second lengths of flexible tube and the mixer portion are formed from a same material.

In an example, a method for forming an inline mixer device is provided. The method includes providing a flexible tube portion, and molding a mixer portion within the tube portion of the same material as the tube portion. In one example, the molding is injection molding. As such, the mixing portion and any mixing elements thereof are molded-in-place relative to the flexible tube portion.

In one example, the method further includes the steps of i) initially inserting a die with a profile defining the mixer portion within the tube portion; ii) injecting a thermoset material into the tube portion and around the die and curing the thermoset material; and then, iii) removing the die from the tube portion such that the cured thermoset material defines the mixer portion. Curing the injected thermoset material bonds the mixer portion to the tube portion. In one example, the bonds are provided by cross-linked bonding. In one example, the cross-link bonding occurs by heating the thermoset material. Notably, the step of removing the die from the tube portion may occur before the mixer portion is fully cured.

Again, this molding process forms-in-place the mixing portion and particularly the mixing elements thereof.

In one example, the step of providing the tube portion includes molding the flexible tube portion. In one example, the molding of the tube portion includes injection molding.

In one example, the steps of injection molding the flexible tube portion and injection molding the mixer portion within the tube portion are performed simultaneously such that the tube portion and mixer portion form a single one-piece molded component formed during a single molding process. The single one-piece molded component is formed from a continuous piece of molded material and not two separately formed pieces bonded or otherwise secured to one another. The single one-piece molded component may exhibit cross-link bonding therein. This cross-link bonding can occur by heating the material after being molded.

In one example, the method includes the steps of i) initially inserting a die with a profile defining the mixer portion within a cavity of a mold, the cavity of the mold defining a profile of the outer periphery of the tube portion; ii) injecting a material into the mold and around the die; and then, iii) removing the die such that the molded material defines the tube portion and the mixer portion.

In one example, the method includes providing a flexible tube portion by providing, at least in part, a first length of flexible tube and a second length of flexible tube. The method further includes inserting a first end of the first length of flexible tube in a mold and inserting a first end of the second length of flexible tube in the mold. Injection molding the mixer portion attaches and fluidly connects the first length of flexible tube with the second length of flexible tube.

In one example, the step of providing the first and second lengths of flexible tube includes providing preformed lengths of flexible tube.

In one example, injection molding the mixer portion forms part of the flexible tube portion.

In one example, the mixer portion includes at least one mixing element. Injection molding the mixer portion includes injection molding the at least one mixing element, at least in part, within one of the first and second lengths of flexible tube.

In one example, the step of injection molding the mixer portion includes molding material forming the mixer portion around an outer periphery of the first end of the first length of flexible tube and around an outer periphery of the first end of the second length flexible tube. In such an arrangement, the mixer portion may be considered to form part of a connection portion that connects two portions of the flexible tube portion. Further yet, the connection portion and/or mixer portion may form part of the flexible tube portion.

In one example, the method includes inserting a die within the mold. Injection molding the mixer portion includes injection molding the mixer portion around the die. The die defines, at least in part, at least one mixing element of the mixer portion.

In one example, the method further includes removing the die from the mixer portion through the first length of tube after the step of injection molding the mixer portion.

In one example, the step of injection molding the mixer portion includes forming part of the flexible tube portion.

In one example, the step of inserting the die includes inserting the die into at least the first end of the first length of tube prior to the step of injection molding the mixer portion. This can be done prior to inserting the first and second lengths of tube into the mold.

In one example, the inner periphery of a mold cavity of the mold defines an outer periphery of the mixer portion.

In one example, the method includes gamma irradiating the mixer portion and flexible tube portion after forming the mixer portion.

In an example, an inline mixer device including a flexible tube portion and a mixer portion is provided. The mixer portion is internal to, integral with and secured along the mixer portion's length to the internal wall of the tube portion. The mixer portion and tube portion are comprised of flexible material.

In one example, the flexible material is a thermoset material.

In one example, the flexible material is silicone.

In one example, the flexible material is a thermoplastic elastomer.

In one example, the material for the tube portion and the material for the mixer portion is the same.

In another example, an inline mixer device including a first length of flexible tube, a second length of flexible tube and a mixer portion is provided. The first length of flexible tube has a first end. The second length of flexible tube has a first end. The mixer portion mechanically connects and fluidly communicates the first end of the first length of flexible tube to the first end of the second length of flexible tube.

In one example, the mixer portion is positioned, at least in part, axially between the first end of the first length of flexible tube and the first end of the second length of flexible tube.

In one example, the mixer portion includes at least one radially inward projecting mixing element that projects radially inward farther than an inner periphery of the first length of flexible tube and an inner periphery of the second length of flexible tube.

In one example, the mixer portion includes at least one radially-inward extending mixing element. The mixing element extends axially into and is secured to an inner periphery of the first length of flexible tube.

In one example, the mixer portion is secured to an outer periphery of the first end of the first length of flexible tube and secured to an outer periphery of the first end of the second length of flexible tube to connect the first and second lengths of flexible tube. This can increase the mechanical securement between the mixer portion and the first and second lengths of flexible tube.

In one example, the first length of flexible tube, second length of flexible tube and the mixer portion are formed from the same material.

In one example, the mixer portion is positioned axially between the first and second lengths of flexible tube. The first and second lengths of flexible tube have a first outer diameter and the mixer portion has a second outer diameter that is larger than the first outer diameter.

In one example, the material is silicone and there is no additional bonding agent between the silicone of the first length of flexible tube, second length of flexible tube and the mixer portion.

In one example, the first length of flexible tube and mixer portion are connected by way of, at least, cross-link bonding of the silicone. The second length of flexible tube and the mixer portion are connected by way of, at least, cross-link bonding of the silicone. This cross-link bonding can occur due to a heating process of the silicone forming the mixer portion.

In one example, a method of mixing a bioprocessing fluid comprises flowing one or more bioprocessing fluids through an inline mixer device as outlined above. The method includes creating increased turbulence within the flow of bioprocessing fluid when the bioprocessing fluid flows through the mixer portion of the inline mixer device.

In an example, an apparatus comprising a tube portion and a mixer portion is provided. The tube portion defines a flow path and the mixer portion is integrally connected to the tube portion. The mixer portion and tube portion being comprised of flexible material. The flexible material being flexible after formation of the apparatus.

In one example, the mixer portion includes at least one mixing element extending into and disrupting the flow path defined by the tube portion.

In one example, the tube portion and the mixer portion are unitary with one another forming a single continuous body of material.

In one example, the tube portion includes a base material having a Shore A durometer of between 10 and 100.

In one example, the tube portion includes at least one preformed section of tubing and the mixer portion is a molded-in-place component molded within the at least one preformed section of tubing.

In one example, the tube portion includes a first preformed section of tubing defining a first portion of the flow path. The tube portion includes a second preformed section of tubing defining a second portion of the flow path. A connection portion connects the first and second preformed sections of tubing and forms part of the tube portion. The connection portion defines a third portion of the flow path of the tube portion. The third portion of the flow path being positioned fluidly between and interconnecting the first and second portions of the flow path.

In one example, the connection portion is a molded-in-place component that is molded to the first and second preformed sections of tubing. The mixer portion is formed as part of the connection portion.

In one example, the connection between the connection portion and the first preformed section of tubing is provided, at least in part, by cross-link bonding between the material of the connection portion and the material of the first preformed section of tubing. The connection between the connection portion and the second preformed section of tubing is provided, at least in part, by cross-link bonding between the material of the connection portion and the material of the second preformed section of tubing.

In one example, a portion of the mixer portion extends into at least one of the first and second preformed sections of tubing.

In one example, the tubing portion and the mixer portion are co-formed during a single molding process to provide the single body of material.

In one example, the tube portion and the mixer portion are flexible.

In one example, the tube portion and mixer portion are formed from silicone.

In one example, the tube portion and mixer portion are integrally connected to one another without the use of a separate adhesive agent formed from a material different than the tube portion or the mixer portion.

In one example, the mixer portion is not formed prior to being integrally connected to the tube portion.

In one example, the mixer portion and the tube portion are formed from a same material.

In one example, the tube portion is a composite structure including a base material and a reinforcing structure embedded within the base material.

In one example, the reinforcing structure is provided by strands of nylon, the nylon strands reducing flexibility of the tube portion in an axial direction to a greater extent than the nylon strands limits bending flexibility of the tube portion.

In one example, a second portion of the mixer portion extends around an outer periphery of the first and second preformed sections of tubing.

In an example, a method for forming an inline mixer device is provided. The method includes providing a flexible tube portion and injection molding a mixer portion of a flexible material, at least in part, to the tube portion.

In one example, the step of injection molding a mixer portion of a flexible material, at least in part, to the tube portion includes injection molding a portion of the mixer portion within a flow passage of the flexible tube portion.

In one example, a material of the tube portion is the same as the flexible material of the mixer portion.

In one example, the method includes cross-link bonding the material of the flexible tube portion to the material of the mixer portion. This may occur by curing or vulcanizing.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-sectional illustration of an inline mixer device forming an inline mixer according to the application;

FIG. 2 is a front view illustration of the inline mixer device of FIG. 1;

FIG. 3 is cross-sectional illustration of a mold and mixer die for forming the inline mixer device of FIG. 1;

FIG. 4 is a cross-sectional illustration of the mold and mixer die of FIG. 3 with the inline mixer device being molded therein;

FIG. 5 is a front view of the mixer die of FIGS. 3 and 4;

FIG. 6 is a cross-sectional illustration of the mold and mixer die of FIG. 3 being used in another method to form the inline mixer device of FIG. 1 with a preformed tube within the mold and the mixer die located within the preformed tube prior to molding the mixing elements;

FIG. 7 is a cross-sectional illustration of the inline mixer device after it has been formed in the mold of FIG. 3 with the mixing elements formed internal to the preformed tube;

FIG. 8 is a cross-sectional illustration of the mold and mixer die being used in another method of forming an inline mixer device where independent preformed tubing sections are connected using an injection molded mixer as illustrated in FIG. 10;

FIG. 9 is a cross-sectional illustration illustrating the mold and mixer die as well as tubing of FIG. 8 having the mixer injection molded within the mold and connecting the tubing sections;

FIG. 10 is a cross-sectional illustration of the resulting inline mixer device formed using the arrangement of FIGS. 8 and 9 removed from the mold; and

FIG. 11 is a simplified illustration of a mixing system incorporating an inline mixer device of FIG. 10 and showing mixing of two separate fluids.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

The present disclosure concerns inline mixers (also referred to herein as “inline mixer devices”), methods of making inline mixers and methods for mixing one or more bioprocessing fluids using inline mixers. A non-exhaustive list of examples of bioprocessing fluids that could be mixed using an inline mixer device according to the disclosure include biopharmaceutical fluids; preparation and media buffers; water used in making buffers; developmental, clinical and commercial drug products, components and formulations; organic solutions and other organic materials, including cells, tissue, byproduct of cell growth; adjuvants; active pharmaceutical ingredients (API's); antibodies; antibody drug conjugates; vaccines; and combinations thereof as well as dilutions thereof.

The apparatus and method could be used for any bioprocessing fluid system including NFF, TFF, Chromatography, Buffer Preparation, Media Preparation, Diluting, Dispensing, Transfer Applications and Bioreactors/Fermenters.

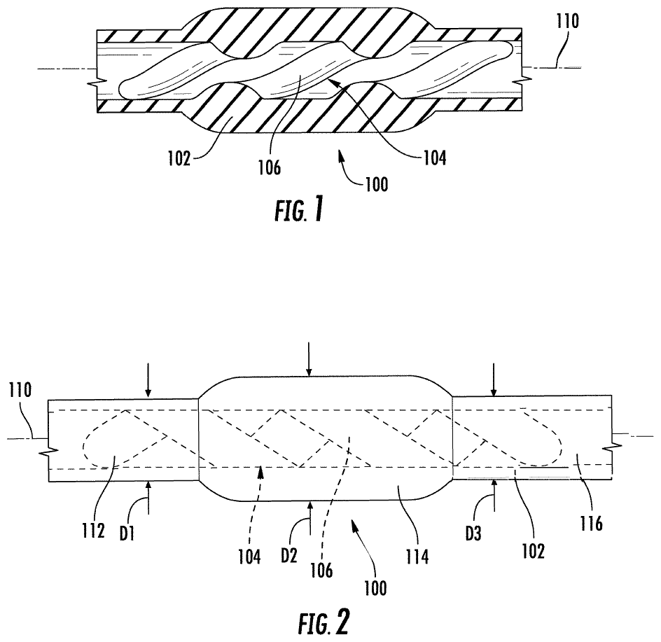

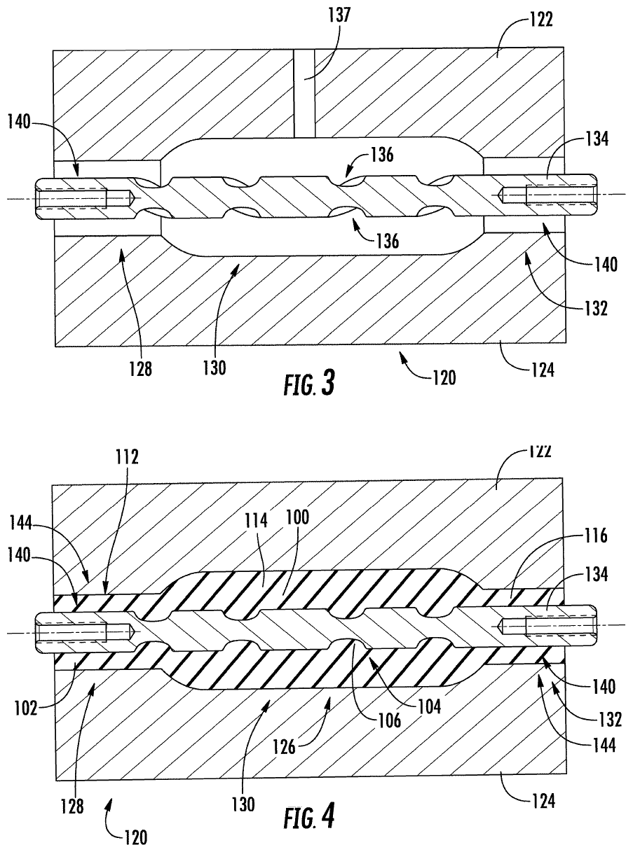

FIGS. 1 and 2 illustrate an example of an inline mixer device 100. The inline mixer device 100 finds particular use in mixing bioprocessing fluids by increasing turbulence within a flow of one or more bioprocessing fluids used in the biopharma industry. The inline mixer device 100 includes a flexible tube portion 102 and a mixer portion 104 internal to the flexible tube portion 102.

Preferably, the mixer portion 104 is integral with the flexible tube portion 102. As used herein, “integral” means that multiple components are connected together such that they cannot be separated without destroying one or more of the components. One example of integral components includes components formed from a single piece of material, such as by way of molding the components simultaneously. Another example of integral components includes a unitary body. Another example of integral components includes the situation where one component is molded directly to another components. In such an example, the component that is molded directly to the other component may be referred to as a mold-in-place or formed-in-place component. In some examples, the integral components may be bonded together. For example, cross-link bonding may be used. In some examples, the cross-link bonding occurs after one component is molded to the other component.

The cross-link bonding may be caused by heating the molded material. This can be performed by heating the mold prior to removing the molded material. This may be referred to as vulcanizing or curing depending on the material that is used.

The mixer portion 104 and flexible tube portion 102 are comprised, preferably, of the same flexible material. However, in other embodiments, the mixer portion 104 may be formed from a different flexible material than the tube portion 102. In a more particular embodiment, the flexible material is a thermoset material, including but not limited to silicone. The thermoset material will typically be cured or vulcanized to generate cross-link bonding therein. One way to form the cross-link bonding is by way of heating the thermoset material after it has been shaped.

In other examples, the flexible material used to form one or more of the tube portion and/or mixer portion 104 is a flexible thermoplastic elastomer. The thermoplastic elastomer would be cooled after it is shaped to give it is final form.

In an example, the material of the inline mixer device 100 meets USP class VI requirements providing bio-compatibility.

In an example, the inline mixer device 100 experiences post formation processing. In one example, the post formation processing includes a sterilizing process, which may include gamma irradiating or autoclaving the formed inline mixer device 100.

In an example, the inline mixer device 100 is disposable. Individual examples may have one of these characteristics or combinations of these characteristics.

As used herein, a “flexible” material shall have a durometer measured on the Shore A scale of between 10 and 100 and preferably between 10 and 90 and at most a durometer of 60 on the Shore D scale. It is noted that a flexible material used in embodiments may have a base material that has the desired durometer value but include reinforcing material or structures embedded therein. A non-exhaustive example would be an inline mixer device formed from silicone that includes nylon strands or webbing embedded for reinforcement to provide increased strength. To the extent that the base material, e.g. silicon in this example, has a durometer with in the desired range, the material and resulting inline mixer device shall be considered flexible. Typically, the reinforcing structure would be used to limit longitudinal stretching of the inline mixer device (e.g. the tube portion 102 thereof) but would provide only limited to no limit on the bending flexibility of the inline mixer device.

The flexibility of the inline mixer device allows for modifying the flow characteristics of the inline mixer device, such as by way of bending or pinching, without requiring the need to replace the tubing or mixing elements.

Typically, the inline mixer device 100 will be a single-use mixer. As such, when used as a single-use mixer, the flexibility mentioned above can facilitate simpler and quicker removal and replacement from the overall system as compared to rigid systems that often required a larger level of disassembly of the system to change out the mixer. However, in other implementations, the inline mixer device 100 may be a multi-use mixer.

In general, the mixer portion 104 is provided by one or more radially inward projecting mixing elements that is/are integral with the tube wall of the flexible tube portion 102 that defines the internal flow path of the tube portion 102.

In one example, the mixer portion 104 includes a plurality of mixing elements in the form of helical projections 106 that extend angularly about a central axis 110 of the flexible tube portion 102. The mixing elements provide a non-cylindrical profile to the flow path defined by the tube portion 102 to increase turbulence and to promote mixing. Other mixing element designs, e.g. non-helical projections could be used. Further, a plurality of distinct radially-projecting projections could be used. In embodiments, one or more mixing elements are provided.

In an example, the mixer portion 104 includes multiple helical projections 106 that extend radially inward. In an example, the helical projections 106 extend angularly in opposite directions so that the fluid flowing through the inline mixer device 100 is exposed to mixing elements of opposite angular orientation at different axial positions along the central axis 110 to improve the mixing characteristics of the inline mixer device 100. The mixer die 134 illustrated in FIG. 5 is an example configured to form a mixer portion 104 that includes multiple helical projections 106 that extend in opposite angular directions.

In one example, the helical projections 106 includes a first pair of helical projections that extend angularly about central axis 110 in the same direction and are generally axially aligned with one another along central axis 110 but that are angularly offset 180 degrees from one another about central axis 110. The helical projections 106 also include a second pair of helical projections that extend angularly about central axis 110 in the same direction and are generally axially aligned with one another along central axis 110 but that are angularly offset 180 degrees from one another about central axis 110. This second pair of helical projections is generally axially offset from the first pair of helical projections. In an example, the ends of the first pair of helical projections is angularly offset from the second pair of helical projections by 90 degrees about central axis 110. Other embodiments may include a first helical projection extending in one angular direction and a second helical projection extending in the opposite angular direction.

In an example, the various different helical projections 106 are distinct from one another and not a continuous projection extending axially along the central axis 110. Further, a helical projection could be formed from a plurality of distinct projections that are aligned with one another in a helical pattern such that when viewed in combination, provide the helical configuration.

While mixing elements in the form of helical projections are provided, other shapes and configurations are contemplated. For example, radially-extending projections that are simple bumps and not helical projections could be incorporated to provide different mixing characteristics. The length, size, pitch, shape, number, and other characteristics of the mixing elements can be altered to provide varying mixing characteristics. Further, different mixing elements can be provided at different locations within the mixer portion. Further, as illustrated by oppositely-oriented helical projections, the mixing elements of the same mixer portion 104 could vary in any of those characteristics, again, to vary the mixing characteristics of the mixer portion 104. Mixing elements can vary in number, length, width, height, hand (rotation), pitch (angle), and cross-sectional geometry. This could very along the length of the mixer portion 104. This could vary based on cross-sectional area of the tube portion 102. The spacing between mixing elements can vary.

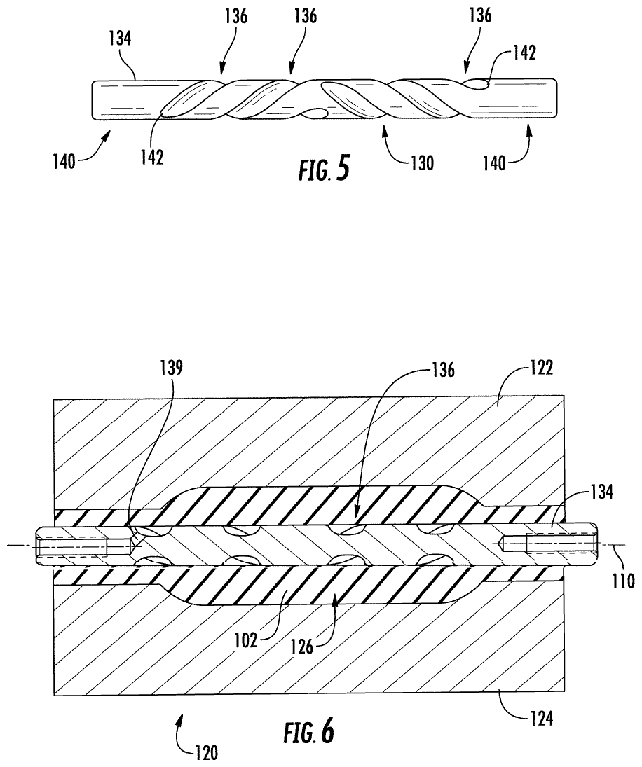

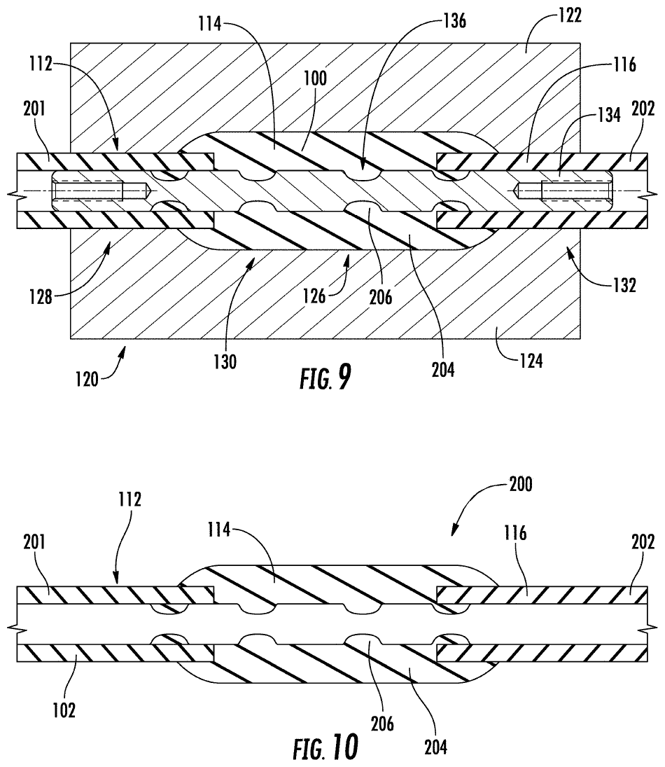

The flexible tube portion 102 and mixer portion 104 may be formed simultaneously (see e.g. FIG. 4). Alternatively, the flexible tube portion 102 may be formed first, and then the mixing elements integrally attached to the inner surface of the sidewall of the flexible tube portion 102 in a separate step (see e.g. FIGS. 7 and 9). This attachment may occur while the mixing elements are being formed, such that the mixing elements are formed-in-place.

In some embodiments, part of the flexible tube portion 102 may be preformed (e.g. by preformed flexible tube) and then part of the flexible tube portion could be formed when forming the mixer portion 104 and/or when connecting the preformed lengths of flexible tube.

It is contemplated that the inline mixer device 100 could be formed from one or more of molding or extruding.

With reference to FIG. 1, the inline mixer device 100, and particularly the flexible tube portion 102 thereof, has a first section 112 having first outer diameter D1, a second section 114 having second outer diameter D2, and a third section 116 having a third outer diameter D3. The second section 114 is positioned axially between the first and third sections 112, 116. The first and third outer diameters D1, D3, in this example are the same and the second outer diameter D2 is different than the first and third outer diameters D1, D3.

The inner diameters of the sidewall portions of the first, second and third sections 112, 114, 116, may be the same or different. In the illustrated examples below, the inner diameters where the mixing elements are not located is the same for all three sections 112, 114, 116.

FIG. 3 illustrates a mold 120 used to form an example of an inline mixer device 100. In this example, the mold has first and second mold halves 122, 124 that combine to form a mold cavity 126. The cavity 126 includes first, second and third regions 128, 130, 132 that correspond to the first, second and third sections 112, 114, 116 of the flexible tube portion 102.

A mixer die 134 is located within the mold cavity 126 to define the mixing element profiles/geometry. The geometry of the die will determine the shape of the internal mixing element(s). The mixer die 134 in this example includes helical flutes 136 that define the arrangement of mixing elements explained above that has two pairs of helical projections 106 that extend angularly in opposite directions.

During molding, the flexible material will be injected into mold cavity 126 and around the mixer die 134 to form the flexible tube portion 102 and mixer portion 104 as a unitary one-piece component that is formed from a continuous piece of material. The material may be injected through one or more material supply channels formed in one or more of the mold halves 122, 124. FIG. 3 illustrates a material supply channel 137 formed in mold half 122. However, more than one material supply channel could be incorporated and could be incorporated in to both mold halves 122, 124. Alternatively, the material may be injected through one or more material supply channels formed in the mixer die 134. FIG. 6 illustrates a material supply channel 139 formed in the mixer die 134. The material supply channel 139 communicates with the geometry (e.g. flutes 136) in the mixer die 134 that defines the mixing elements of the resulting mixer portion.

FIG. 4 illustrates the mold 120 with the inline mixer device 100 in an as molded state within the mold cavity 126. Once the material forming the inline mixer device 100 has sufficiently set (e.g. such that the inline mixer device 100 will maintain its shape), the mold halves 122, 124 will be separated and the mixer die 134 will be removed axially through the internal flow passage of the inline mixer device 100.

FIG. 5 illustrates the mixer die 134 removed from the mold 120 to illustrate the helical flutes 136. The profile of the helical flutes 136 is the negative of the helical projections 106 discussed previously that would be formed thereby during the molding process.

With additional reference to FIGS. 3 and 4 and primarily FIG. 4, in this example, the helical flutes 136 do not extend the entire length of the mixer die 134 such that the end portions 140 that are offset from the outer most ends 142 of the helical flutes 136 are smooth. These end portions 140 cooperate with the first and third regions 128, 132 of the mold cavity 120 to form a smooth inner surface at the ends 144 of the inline mixer device 100. The smooth inner surface allows the inline mixer device 100 to be connected with a good seal to connectors such a tri-clamp, y-, t- or cross tube connections, which are generally known in the biopharma industry. For instance, a portion of the connector can be inserted into the smooth end portions of the inline mixer device to form a good seal therebetween. Thus, it can be appreciated how quick and easy replacement of the inline mixer device 100 can occur due to the flexibility of the assembly.

With reference to FIG. 4, in this example, the helical projections 106 of one pair of the helical projections 106 extend within a portion of the first section 112 and a portion of the second section 114. The other helical projections 106 of the other pair of the helical projections 106 extend within a portion of the second section 114 and a portion of the third section 116. Again, in this example, the mixing elements do not extend the entire length of the flexible tube portion 102 to provide the smooth inner surface proximate ends 144 for connecting to connectors.

FIGS. 6 and 7 illustrate a second process for forming an inline mixer device 102. In this process, flexible tube portion 102 is first formed and then the mixer portion 104 is added to the inner surface of the flexible tube portion 102. Preferably, the material used to form mixer portion 104 is the same as the material to form tube portion 102.

FIG. 6 illustrates the mold 120 with the section of flexible tube portion 102 already formed and/or at least partially cured and located within the mold cavity 126. The mixer die 134 has been inserted into the central cavity that forms the flow passage of the flexible tube portion 102. While being shown in mold 120, the tube portion 102, in other processes, need not be in a mold 120 when the mixer die 134 is inserted.

In FIG. 6, helical flutes 136 of the mixer die 134 are free of any material at this time. As such, a mixer portion 104 and corresponding mixing elements have not been formed.

With reference to FIG. 7, material has been injected via channel 139 in the mixer die 134 (see FIG. 6) into the helical flutes 136 to form the mixer portion 104 and its corresponding mixing elements, again, in this example, helical projections 106.

Once the material, e.g. silicone, is sufficiently cured, the mixer die 134 can be pulled out of the tube portion 102 leaving the negative of the mixer die 134 as the mixer portion 104 integrally secured to the inner surface of the sidewall of the flexible tube portion 102.

In an example, where the flexible tube portion 102 and mixer portion 104 are formed using this multi-step process, a material such as silicone provides positive results for integrally securing the mixing elements to the previously formed flexible tube portion 102, because uncured flowable silicone has good adhesive properties with silicone that has previously, at least partially, cured, e.g. a previously-cured or previously-formed flexible tube portion 102.

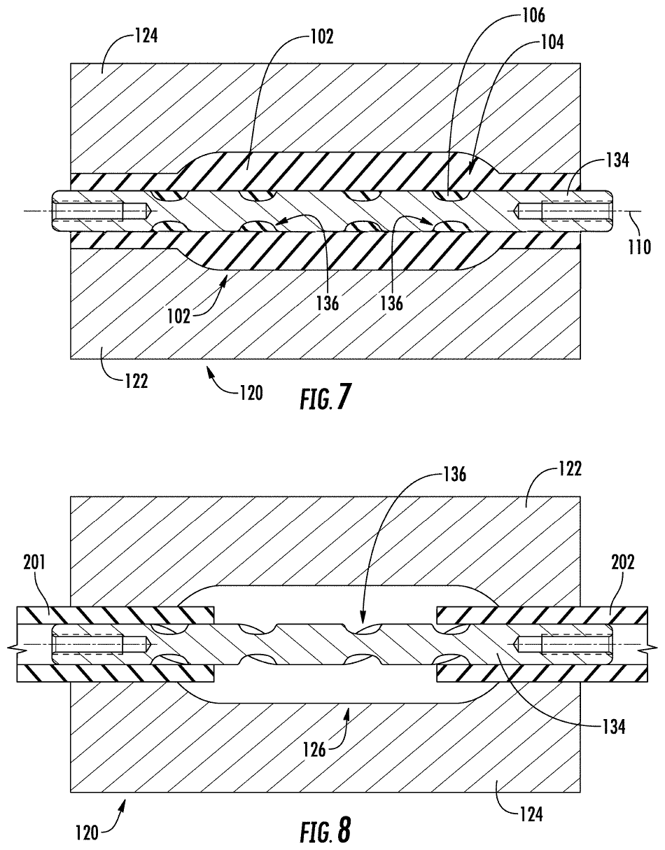

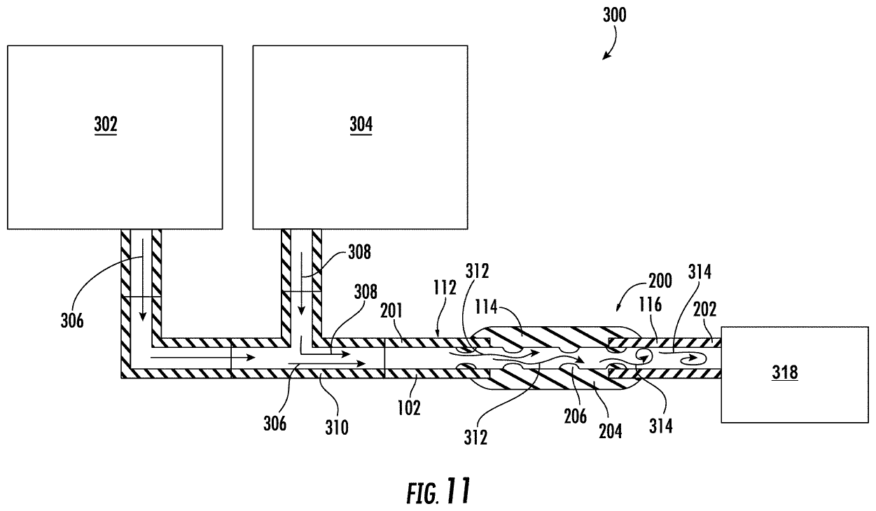

FIGS. 8 and 9 illustrate a further method for forming inline mixer device 200. The resulting inline mixer device 200 is illustrated in FIG. 10. In this embodiment, the flexible tube portion is formed by two separate lengths of flexible tube 201, 202, as well as part of the mixer portion 204. Thus, the mixer portion 204 provides part of the flexible tube portion and particularly the flow path defined by the flexible tube portion of this example.

The mixer portion 204 mechanically secures the first length of flexible tube 201 to the second length of flexible tube 202 as well as fluidly connects the first and second lengths of flexible tube 201, 202. Thus, the mixer portion 204 may be considered a connection portion.

FIG. 8 illustrates the two lengths of flexible tube 201, 202 inserted into mold 120, with the free ends of the lengths of flexible tube 201, 202 positioned within internal cavity 126 of the mold 120. The mold 120 will be clamped around the outer periphery of the first and second lengths of the flexible tube 201, 202 to prevent leakage of the material that is molded therein between the lengths of flexible tube 201, 202 and the inner periphery of the mold 120.

The first length of flexible tube 201 is located in region 128 of the cavity 126, the second length of flexible tube 202 is located in region 132 of the cavity 126 and the ends of the first and second lengths of flexible tube 201, 202 are located in a generally fully exposed configuration within region 130 of the cavity 126. See FIG. 4 for the identified regions of cavity 126.

In this embodiment, mixer die 134 is inserted into the ends of both the first and second lengths of flexible tube 201, 202. Typically, this will be done before clamping the tubing between the mold halves. However, in other embodiments, the mixer die 134 can extend into only one of the first or second lengths of flexible tube 201, 202. Further yet, in some embodiments, the mixer die 134 does not extend into either length of flexible tube 201, 202.

It is preferred that the helical flutes 136 of the mixer die 134 extend axially into the preformed first and second lengths of flexible tube 201, 202 such that the resulting mixer portion 204 and mixing elements thereof extend, at least in part, axially into the first and second lengths of the flexible tube 201, 202. As such, the mixer portion 204 is attached to the inner periphery of the lengths of flexible tube 201, 202. This strengthens the connection of the first and second lengths of flexible tube 201, 202 provided by mixer portion 204. However, in some embodiments, the mixing elements do not extend into either of the lengths of flexible tube 201, 202 or into just one of the lengths of flexible tube 201, 202.

Further, it is preferred that the lengths of flexible tube 201, 202 are positioned within the internal cavity 126 of the mold 120 such that a portion of the outer periphery of the ends of the first and second lengths of flexible tube 201, 202 are freely exposed such as in FIG. 8. This allows the material that forms mixer portion 204 to engage and attach to the exposed radially outer portion of the first and second lengths of the flexible tube 201, 202 to further attach the mixer portion 204 to the lengths of flexible tube 201, 202. This improves connection therebetween.

Materials that provide cross-linked bonding when combined provide strong connections between the various components. In some implementations, the material of the first and second lengths of flexible tube 201, 202 and the material of the mixer portion 204 form a unitary body after molding of the mixer portion 204.

In some embodiments, the material that forms mixer portion 204 need not extend around or connect to the outer periphery of the lengths of flexible tube 201, 202.

In this example, the lengths of flexible tube 201, 202 are preformed prior to being inserted into the mold 120. Further, in this embodiment, the mixer portion 204 is at least partially positioned axially between the ends of the first and second lengths of flexible tube 201, 202. In this configuration, a portion of the mixer portion 204 positioned between the lengths of flexible tube 201, 202 may be considered to form part of the flexible tube portion of the resulting inline mixer device 200. Thus, the resulting mixing elements (e.g. projections 206) are integrally formed internal to the flexible tube portion of the inline mixer device.

The molded component in this embodiment may be considered a connection portion. This connection portion both connects the preformed lengths of tubing 201, 202, provides part of the flexible tube portion, and provides the mixing portion 204.

Further, in the embodiments where the material that forms mixer portion 204 extends around the ends of the first and second lengths of flexible tube 201, 202, the outer diameter of the mixer portion 204 is typically larger than the outer diameter of the first and second lengths of flexible tube 201, 202.

Once molded and sufficiently cured, the mixer die 134 can be removed. This is done by extracting the mixer die 134 through one of the lengths of flexible tube 201, 202. Typically, a rod is connected to the internal thread in one end of the mixer die 134 so that the mixer die 134 can be removed from the inside of the inline mixer device 200. Threading is illustrated, at least in part, in mixer die 134 by dashed lines and a cavity in the ends of mixer die 134. Typically, but not always, the rod would be inserted into the corresponding length of flexible tube 201, 202 prior to the molding process.

This process of forming the inline mixer device 200 allows for an easy way to provide substantially unlimited length of tubing on either side of the mixer portion 204.

In preferred examples of the process described above, no crevices or gaps are formed between the mixer portion and the wall of the tube portion because the mixing elements are molded simultaneously with or directly to the walls of the flexible tube portion. This can be beneficial for e.g., protein compatibility.

While a single die is illustrated as being used above, other processes, such as when one or more mixing elements are formed, could use a plurality of mixing dies, such as mixing dies arranged in series. This could be useful when multiple mixing portions are provided in a single inline mixer device. Again, the mixing elements could have a same profile or profiles having different characteristics. For example, a single inline mixer device could have multiple, axially spaced-apart mixer portions integrally connected together by intermediate tube sections that are free of mixing elements. These mixer portions could have the same or different mixing elements.

By using a flexible tube portion and flexible mixer portion with flexible mixing elements, the inline mixer devices described above are flexible to bend in any shape the tube portion can bend. The flexibility reduces or eliminates stresses at attachment points, such as attaching to or between any combination of rigid connector, tank, bag, or other component. Further, the flexible mixer portion can bend as well. Further, the flexibility allows for altering flow characteristics (e.g. by way of bending or pinching) through the inline mixer device to modify mixing characteristics of the device.

The inline mixer devices described above and particularly the mixer portion thereof can be of any length and the flexible tube portion can be of any inner diameter. Again, mixing elements having different geometry can be used to vary the degree of turbulence (e.g. mixing) of the mixer portion. This can be done by changing the length of the mixing elements, changing the shape of the mixing elements, changing the number of the mixing elements, changing the extent the mixing elements extend radially inward, etc.

The mixer portion can be put in a small diameter tube such as a flexible tube having an inner diameter of ⅛ inch. The mixing can include inline dilution, spiking, supplementing, etc.

The inline mixer devices described above and corresponding tube portion and mixer portion(s) can be formed as one continuous piece or one integral unit, which separates the operator from cytotoxic products. The inline mixer devices described above and corresponding tube portion and mixer portion can be disposed of without opening it, eliminating the need for cleaning, which could expose the operator to the product being mixed.

By using inline mixer devices as described above, the subject inline mixer does not require a large mixing reservoir that would typically need to be cleaned and reused, which can increase the cost and expense of a mixing system.

By using the molding techniques of molding the flexible tube portion and mixer portion simultaneously, or molding the mixer portion into a preformed flexible tube portion, or molding the mixer portion to separate lengths of preformed flexible tube, the mixer portion may be bonded along its entire length to the internal wall of the flexible tube portion. No separate adhesive or bonding material/agent, e.g. a different, material, is provided to secure the mixer portion to the flexible tube portion. As noted above, this bonding can be very strong when materials that exhibit cross-linked bonding are used.

In preferred embodiments, the mixing elements do not have a central member from which the mixing elements extend radially outward therefrom. Instead, the mixing elements, in preferred embodiments, only extend radially inward from the sidewall defining the flexible tubing/flow passage through which the bioprocessing fluid flows. This allows for removal of the mixer die during manufacturing and after sufficient cure of the molded mixer portion.

FIG. 11 illustrates an inline mixer device 200 according to the application in use within a mixing system 300. The inline mixer device 200 is connected to two sources of fluid 302, 304 that are to be mixed by the inline mixer device 200.

Fluid 306 is flowing out of the first fluid source 302 and fluid 308 is flowing out of second fluid source 304. The flows of fluid 306 and fluid 308 combine at t-connector 310 and then flow into inline mixer device 200 at first section 112. The arrows representing fluid 306, 308 have been illustrated as relatively straight arrows showing a relatively low amount of turbulence in these flows of fluid at this location.

As the combined flows of fluid 306 and fluid 308 flow downstream through mixer portion 204, turbulence within the flow of fluid increases as illustrated by arrows 312 beginning to bend. Mixed fluid exiting the mixer portion 204, illustrated by arrows 314, has a high level of mixing due to the increase in turbulence within the fluid flow generated by mixer portion 204. The increased level of turbulence is illustrated by the increased amount of curvature in arrows 314. This increased turbulence causes a high level of mixing between fluids 306, 308.

The mixed fluid 314 exiting mixer portion 204 can then flow to a container 318 where it is stored. Alternatively, the mixed fluid 314 could flow to other downstream systems or devices where the mixed fluid 314 is used.

Fluid sources 302, 304 could be gravity fed or include pumps to pressurize the flow of fluids 306, 308.

As noted above, the mixer portion 204 can be configured so as to provide a desired amount of mixing of fluids 306, 308. Thus, if more or less mixing is required, the inline mixer 200 could be replaced with another inline mixer having different mixing characteristics.

While system 300 is illustrated using an inline mixer device 200, any inline mixer described herein could be employed in system 300.

In some implementations and as noted above, the inline mixer device 200 may be one-time use such that once all of fluid 306 and fluid 308 (or the desired amount of fluids 306, 308) is mixed, the inline mixer device 200 is discarded and replaced with a new inline mixer device for use in a subsequent mixing process. Other components of system 300 could be one-time use, such as t-connector 310 or any associated tubing. Alternatively, in some implementations, the tubing and t-connector 310 could be fixed components of system 300. As noted above, in this situation, the flexibility of the inline mixer device could facilitate easy replacement.

1 references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An inline mixer device, comprising:
a. a flexible tube portion; and
b. a mixer portion internal to and integral with the tube portion, the mixer portion and tube portion being comprised of flexible material.

2. The inline mixer device as in claim 1, wherein:
the mixer portion and the tube portion are formed from a same flexible material
the mixer portion has a length, the mixer portion is bonded along at least a portion of the length to an internal wall of the tube portion by molding the mixer portion to the internal wall of the tube portion; and
the bond between the mixer portion and the tube portion does not include a separate bonding material.

3-5. (canceled)

6. The inline mixer device as in claim 1, wherein:
a. the tube portion has a first section, a second section and a third section, the second section being positioned axially between the first and third sections, the first and third sections having a first outer diameter and the second section having a second outer diameter different than the first outer diameter;
b. the first section has a first wall portion, the second section has a second wall portion, the third section has a third wall portion; and
c. the mixer portion projects radially inward from the first wall portion, the second wall portion and the third wall portion.

7. (canceled)

8. The inline mixer device of claim 6, wherein:
the first and second wall portions are formed prior to the second wall portion;
the second wall portion is molded to the first and second wall portion;
the mixer portion has a first mixing element and a second mixing element, the first and second mixing elements being molded mixing elements; and
the first mixing element being distinct from the second mixing element, the first mixing element extending radially inward from the first wall portion and the second wall portion, the second mixing element extending radially inward from the third wall portion and the second wall portion.

9-14. (canceled)

15. The inline mixer device of claim 1, wherein the flexible tube portion includes a first length of flexible tube defining a first end and a second length of flexible tube defining a first end, the mixer portion fluidly and mechanically connects the first end of the first length of flexible tube to a-the first end of the second length of flexible tube.

16. The inline mixer device of claim 15, wherein the mixer portion forms a portion of the flexible tube and is axially positioned between the first end of the first length of flexible tube and the first end of the second length of flexible tube.

17. The inline mixer device of claim 15, wherein a portion of the mixer portion extends into each of the first and second lengths of flexible tube and around the outer periphery of at least a portion of each of the first and second lengths of flexible tube.

18. (canceled)

19. A method for forming an inline mixer device, comprising the steps of:
a. providing a flexible tube portion, and
b. injection molding a mixer portion of a flexible material, at least in part, to the tube portion.

20-23. (canceled)

24. The method of claim 19, wherein:
the step of providing the tube portion includes injection molding the flexible tube portion; and
the steps of injection molding the flexible tube portion and injection molding the mixer portion within the tube portion are performed simultaneously such that the tube portion and mixer portion form a single one-piece molded component formed during a single molding process.

25. The method of claim 24, further including the steps of:
i) initially inserting a die with a profile defining at least one mixing element of the mixer portion within a cavity of a mold defining a profile of the outer periphery of the tube portion;
ii) injecting a material into the mold and around the die; and then,
iii) removing the die such that the material defines the tube portion and the mixer portion.

26. The method of claim 19, wherein providing a flexible tube portion includes providing a first length of flexible tube and a second length of flexible tube, the method further includes:
inserting a first end of the first length of flexible tube in a mold;
inserting a first end of the second length of flexible tube in the mold; and
wherein injection molding the mixer portion attaches and fluidly connects the first length of flexible tube with the second length of flexible tube.

27. (canceled)

28. The method of claim 26, wherein:
the mixer portion includes at least one mixing element and wherein injection molding the mixer portion includes injection molding the at least one mixing element, at least in part, within one of the first and second lengths of flexible tube; and
the step of injection molding the mixer portion includes molding material forming the mixer portion around an outer periphery of the first end of the first length of flexible tube and around an outer periphery of the first end of the second length flexible tube.

29-40. (canceled)

41. An inline mixer device, comprising:
a. a first length of flexible tube having a first end;
b. a second length of flexible tube having a first end; and
c. a mixer portion mechanically connecting and fluidly communicating the first end of the first length of flexible tube to the first end of the second length of flexible tube.

42. The inline mixer device of claim 41, wherein the mixer portion is positioned, at least in part, axially between the first end of the first length of flexible tube and the first end of the second length of flexible tube.

43. The inline mixer device of claim 41, wherein:
the mixer portion includes at least one radially inward projecting mixing element;
the mixing element projects radially inward farther than an inner periphery of the first length of flexible tube and an inner periphery of the second length of flexible tube; and
the mixing element extends axially into and is secured to an inner periphery of the first length of flexible tube.

44. (canceled)

45. The inline mixer device of claim 41, wherein the mixer portion is secured to an outer periphery of the first end of the first length of flexible tube and secured to an outer periphery of the first end of the second length of flexible tube to connect the first and second lengths of flexible tube.

46. (canceled)

47. The inline mixer device of claim 41, wherein the mixer portion is positioned axially between the first and second lengths of flexible tube, the first and second lengths of flexible tube have a first outer diameter and the mixer portion has a second outer diameter that is larger than the first outer diameter.

48. (canceled)

49. The inline mixer device of claim 41, wherein:
the first length of flexible tube and the mixer portion are integrally connected, the integral connection between the first length of flexible tube and the mixer portion includes cross-link bonding; and
the second length of flexible tube and the mixer portion are integrally connected, the integral connection between the second length of flexible tube and the mixer portion includes cross-link bonding.

50. The inline mixer device of claim 49, wherein the integral connection between the first length of flexible tube and the mixer portion includes cross-link bonding and the integral connection between the second length of flexible tube and the mixer portion includes cross-link bonding.

51. An apparatus comprising:
a tube portion defining a flow path, the tube portion includes at least one preformed section of tubing; and
a mixer portion integrally connected to the tube portion, the mixer portion is a molded-in-place component molded within the at least one preformed section of tubing, the mixer portion including at least one mixing element extending into and disrupting the flow path defined by the tube portion, the mixer portion and tube portion being comprised of flexible material.

52-55. (canceled)

56. The apparatus of claim 51, wherein:
the at least one preformed section of tubing includes a first preformed section of tubing defining a first portion of the flow path;
the at least one preformed section of tubing includes a second preformed section of tubing defining a second portion of the flow path;
a connection portion connects the first and second preformed sections of tubing and forms part of the tube portion, the connection portion defines a third portion of the flow path of the tube portion, the third portion of the flow path being positioned fluidly between and interconnecting the first and second portions of the flow path; and
the connection portion is a molded-in-place component that is molded to the first and second preformed sections of tubing; and
the mixer portion is formed as part of the connection portion.

57. (canceled)

58. The apparatus of claim 56, wherein:
the connection between the connection portion and the first preformed section of tubing is provided, at least in part, by cross-link bonding between the material of the connection portion and the material of the first preformed section of tubing; and
the connection between the connection portion and the second preformed section of tubing is provided, at least in part, by cross-link bonding between the material of the connection portion and the material of the second preformed section of tubing.

59. The apparatus of claim 56, wherein a portion of the mixer portion extends into at least one of the first and second preformed sections of tubing and
wherein a second portion of the mixer portion extends around an outer periphery of the first and second preformed sections of tubing.

60-72. (canceled)
